(19) United States
(12) Patent Application Publication
(10) Pub. No.: US 2010/0296690 A1
(43) Pub. Date: Nov. 25, 2010

(54) ELECTRO-ACOUSTIC TRANSDUCER

(75) Inventors: YI SHAO, Shenzhen (CN); XING-ZHI HUANG, Shenzhen (CN)

Correspondence Address: Jamie Zheng, 3524 Waverley Street, Palo Alto, CA, 94306, US

(73) Assignees: AAC ACOUSTIC TECHNOLOGIES (SHENZHEN) CO., LTD, Shenzhen (CN); AMERICAN AUDIO COMPONENTS INC., La Verne, CA (US)

(21) Appl. No.: 12/697,282

(22) Filed: Jan. 31, 2010

(30) Foreign Application Priority Data
May 22, 2009 (CN) 200910107473.0

(51) Int. Cl. H04R 1/00

(52) U.S. Cl. 381/400

(57) ABSTRACT

An electro-acoustic transducer is disclosed. The electro-acoustic transducer includes a case, a magnetic circuit and a vibrating device. The magnetic circuit includes a magnetic bowl coupled to the case, a magnet positioned in the magnetic bowl, a pole plate covering the magnet. A magnetic gap is formed by the magnet and the magnetic bowl. The vibrating device includes a diaphragm vibrating along a vibrating direction, and a voice coil connected to the diaphragm. The pole plate has a first top surface, a first bottom surface, and a first through hole extending from the first top surface to the first bottom surface. A projection of the first through hole along the vibrating direction overlaps at least a part of the magnetic gap.

### BACKGROUND OF THE INVENTION

1. Field of the Invention

The present invention generally relates to the art of electro-acoustic transducers and, more particularly, to a micro speaker used in an electronic device.

2. Description of Related Art

An electronic device, such as a cellular phone, a camcorder, a PDA, a digital camera, or a notebook computer, provides a space for accommodating a micro speaker therein. Nowadays, a speaker with high quality audio performance and miniature size is desired.

A related speaker comprises a case, a magnet positioned in the case, a pole plate disposed on the magnet, a diaphragm supported by the case, a voice coil attached to the diaphragm, and a cover pressing on a peripheral portion of the diaphragm. For electrically connecting the speaker to an external PCB, a plurality of terminals is provided and is connected to leads of the voice coil. When alternating currents go through the voice coil, the magnet will drive the voice coil to vibrate and the diaphragm will also vibrate with the voice coil accordingly, which converts the currents into sound waves.

With the increase of the magnetic circuit area, the area of the diaphragm also increases. The related speaker cannot provide enough leaking channels but the gap between the pole plate and the voice coil. However, the distance between the pole plate and the voice coil becomes shorter and shorter as the size of the speaker is smaller and smaller. Therefore, the leaking depending on the gap is not enough, which influences the performance of the speaker. So an improved electro-acoustic transducer is required to overcome the disadvantage mentioned above.

### SUMMARY OF THE INVENTION

According to the present invention, an electro-acoustic transducer comprises a case, a magnetic circuit and a vibrating device. The magnetic circuit comprises a magnetic bowl coupled to the case, a magnet positioned in the magnetic bowl, and a pole plate covering the magnet. A magnetic gap is formed by the magnet and the magnetic bowl. The vibrating device includes a diaphragm supported by the case and vibrating along a vibrating direction, and a voice coil connected to the diaphragm. The pole plate comprises a first top surface, a first bottom surface, and a first through hole extending from the first top surface to the first bottom surface. A projection of the first through hole along the vibrating direction overlaps at least a part of the magnetic gap.

Other features of the present invention will become more apparent to those skilled in the art upon examination of the following drawings and detailed description of an exemplary embodiment.

### BRIEF DESCRIPTION OF THE DRAWINGS

FIG. 1 is an isometric view of an electro-acoustic transducer in accordance with one embodiment of the present invention;

FIG. 2 is a schematic exploded view of the electro-acoustic transducer in FIG. 1;

FIG. 3 is a schematic cross-sectional view of the electro-acoustic transducer in FIG. 1; and

FIG. 4 is an enlarged view of Section A in FIG. 2.

### DETAILED DESCRIPTION OF THE PREFERRED EMBODIMENT

Reference will now be made to describe the exemplary embodiment of the present invention in detail.

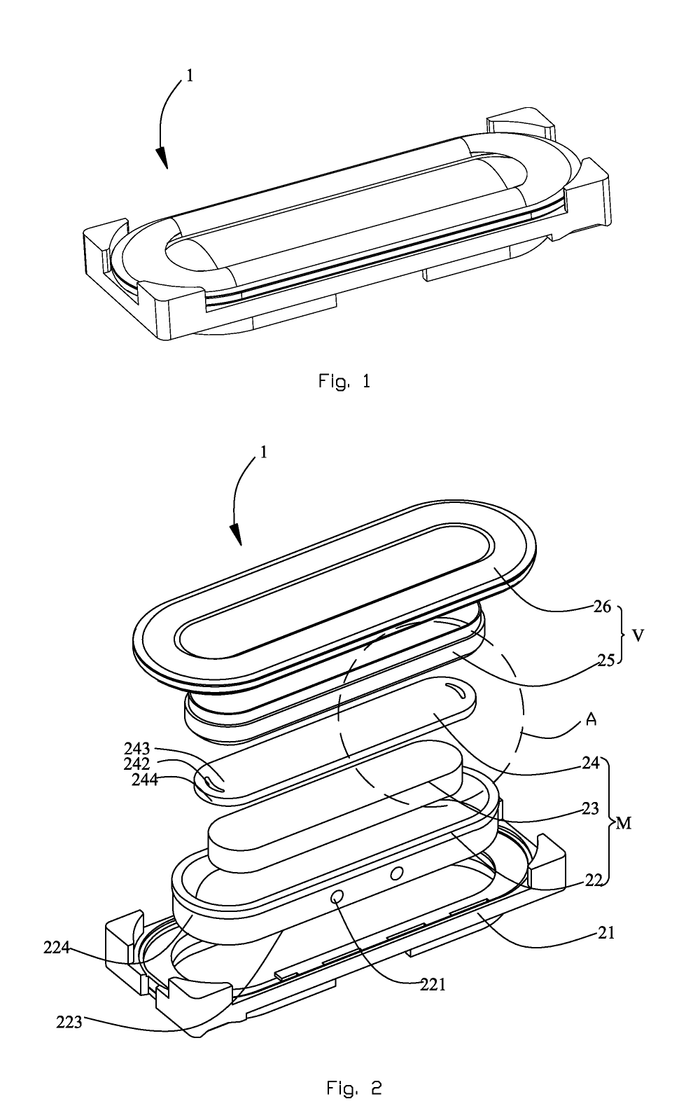

Referring to FIG. 1, an electro-acoustic transducer 1 in accordance with an embodiment of the invention is generally used in a mobile phone.

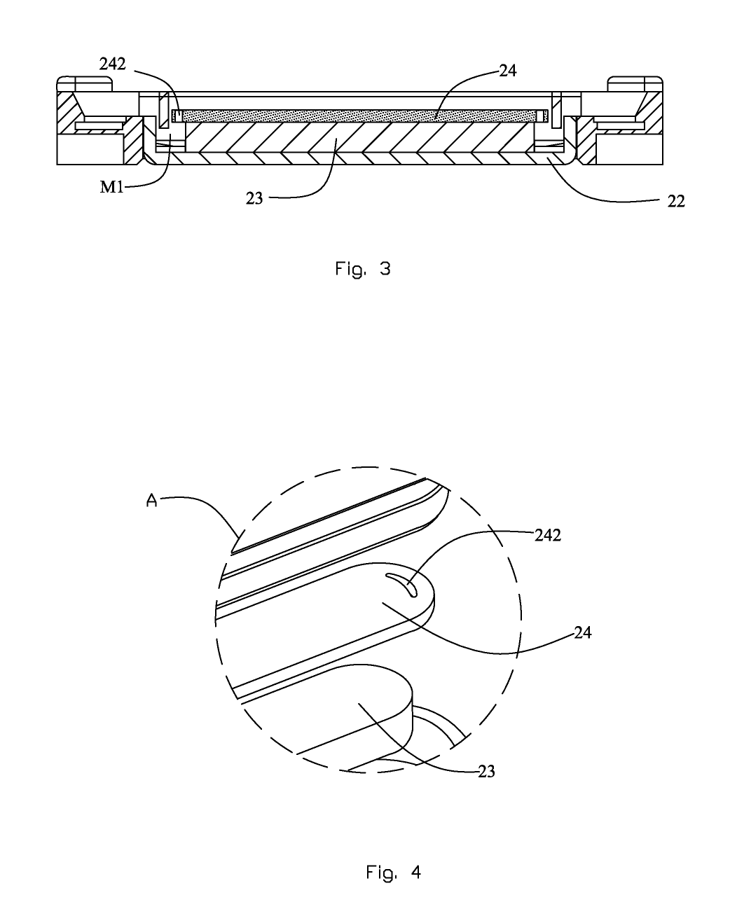

Referring to FIGS. 2-3, the electro-acoustic transducer 1 comprises a case 21, a magnetic circuit M providing a magnetic gap M1, a vibrating device V. The magnetic circuit M comprises a magnetic bowl 22 coupled to the case 21, a magnet 23 positioned in the magnetic bowl 22 and a pole plate 24 covering the magnet 23. The magnetic gap M1 is formed by the magnet 23 and the magnetic bowl 22. The vibrating device V comprises a diaphragm 26 supported by the case 21 and a voice coil 25 attached to the diaphragm 26. The voice coil 25 is partially received in the magnetic gap Ml.

The pole plate 24 comprises a first top surface 243, a first bottom surface 245, and a first side wall 244 connecting the first top surface 243 and the first bottom surface 145. The pole plate 24 further includes a first through hole 242 extending from the first top surface 243 to the first bottom surface 245. At least a part of the through hole 242 has a projection, along a direction parallel to the vibrating direction of the diaphragm 26, overlapping at least a part of the magnetic gap. Such structure provides a leaking channel for the vibration of the diaphragm 26, which can not only improve the performance of the speaker but also reduce the cost.

The magnet bowl 22 defines a second bottom surface 223 and a second side wall 224 extending from the second bottom surface 223 perpendicularly. The magnet bowl 22 defines a cavity for receiving the magnet 23. A second through hole 221 is arranged in the second side wall 224.

Referring to FIG. 4, the pole plate 24 has an extending part protruding from an edge of the magnet 23 and the first through hole 242 is at least partially located in the extending part, which ensures that the projection of the first through hole along the vibrating direction of the diaphragm can at least partially overlap the magnetic gap.

While the present invention has been described with reference to a specific embodiment, the description of the invention is illustrative and is not to be construed as limiting the invention. Various of modifications to the present invention can be made to the exemplary embodiment by those skilled in the art without departing from the true spirit and scope of the invention as defined by the appended claims.

What is claimed is:

1. An electro-acoustic transducer comprising:
a case;
a magnetic circuit including:
a magnetic bowl coupled to the case,
a magnet positioned in the magnetic bowl,
a pole plate covering the magnet, and comprising a first top surface, a first bottom surface, and a first through hole extending from the first top surface to the first bottom surface;
a magnetic gap formed by the magnet and the magnetic bowl;
a vibrating device including:
a diaphragm supported by the case and vibrating along a vibrating direction,
a voice coil connected to the diaphragm, wherein
a projection of the first through hole along the vibrating direction overlaps at least a part of the magnetic gap.

2. The electro-acoustic transducer as described in claim 1, wherein the projection of the first through hole is located in the magnetic gap entirely.

3. The electro-acoustic transducer as described in claim 1, wherein the magnet bowl comprises a second bottom surface, a second side wall extending from the periphery of the second bottom surface perpendicularly, and a second through hole located in the second side wall.

4. The electro-acoustic transducer as described in claim 2, wherein the magnet bowl comprises a second bottom surface, a second side wall extending from the periphery of the second bottom surface perpendicularly, and a second through hole located in the second side wall.

5. An electro-acoustic transducer comprising:
a case;
a magnetic bowl coupled to the case;
a magnet positioned in the magnetic bowl;
a pole plate comprising a first top surface, a first bottom surface, a first through hole extending from the first top surface to the first bottom surface and an extending part protruding from an edge of the magnet;
a diaphragm supported by the case and vibrating along a vibrating direction,
a voice coil connected to the diaphragm and received in a magnetic gap provided by the magnetic bowl and the magnet; wherein
the first through hole is at least partially located in the extending part.

6. The electro-acoustic transducer as described in claim 5, wherein the projection of the first through hole is positioned in the magnetic gap entirely.

7. The electro-acoustic transducer as described in claim 5, wherein the magnet bowl comprises a second bottom surface and a second side wall extending from the periphery of the second bottom surface perpendicularly, a second through hole is disposed in the second side wall.

8. The electro-acoustic transducer as described in claim 6, wherein the magnet bowl comprises a second bottom surface and a second side wall extending from the periphery of the second bottom surface perpendicularly, a second through hole is disposed in the second side wall
